(19) United States
(12) Patent Application Publication
(10) Pub. No.: US 2003/0212591 A1
(43) Pub. Date: Nov. 13, 2003

(54) Methods for marketing newsletter subscriptions with direct response mailings without use of an envelope

(75) Inventor: Gregrey E. Lindberg, Chapel Hill, NC (US)

Correspondence Address: JENKINS & WILSON, PA, 3100 TOWER BLVD, SUITE 1400, DURHAM, NC, 27707, US

(73) Assignee: Eli Research, Inc.

(21) Appl. No.: 10/346,666

(22) Filed: Jan. 17, 2003

Related U.S. Application Data
(60) Provisional application No. 60/379,482, filed on May 10, 2002.

(51) Int. Cl. G06F 17/60

(52) U.S. Cl. 705/10

(57) ABSTRACT

A method for marketing a newsletter subscription includes creating a newsletter having content of interest to a prospective subscriber. A continuation notice is also created. The continuation notice includes information that allows the subscriber to order the newsletter. The continuation notice is printed on a page that is at least the same size as pages of the newsletter. The continuation notice and the newsletter are combined and mailed to the prospective subscriber without using an external envelope.

### RELATED APPLICATIONS

This application claims the benefit of U.S. Provisional Patent Application Serial No. 60/379,482, filed May 10, 2002, the disclosure of which is incorporated herein by reference in its entirety.

### TECHNICAL FIELD

The present invention relates to methods for marketing newsletter subscriptions. More particularly, the present invention relates to a method for creating a mailpiece that increases the likelihood of successful mailpiece marketing.

### RELATED ART

Direct mail has long been used as a medium for marketing newsletter subscriptions. One popular method of marketing a newsletter subscription has long been the force free trial. “As the name implies, a force free trial (FFT) is a trial subscription that is forced on the prospect.” (Patti Wysocki, The Ultimate Guide to Newsletter Publishing, Newsletter and Electronic Publishers Association, 1999) In a FFT mailing, “the prospect is mailed the newsletter just as if he or she were the actual subscriber. The thought is to get the prospect used to reading the newsletter so he or she will certainly want to continue the subscription.” (See id.)

Typically, a force free trial mailing consists of a current, live issue of the newsletter combined with a cover letter and a separate subscription form. Typically, these order forms have been called “continuation notices,” in that they invite the prospect to continue receiving the publication. All of these documents (the newsletter and the continuation notice) have, prior to the present invention, typically been enclosed in a #10 or 9×12 envelope.

The problem with this strategy, however, is that the current content in the newsletter and marketing verbiage in the cover letter is what really sells the prospect on the newsletter. So by adding an envelope to the package, the marketer has created a barrier between the prospect and the sale, because the prospect must open the envelope before being able to read the newsletter and cover letter. Typically some teaser copy is placed on the outside of the envelope, but this copy is not nearly as effective as the full newsletter and cover letter contained therein.

Some marketers have tried to solve this problem by the creation of a “wrap” with a perforated order form that is separately detachable. While the wrap does allow the presentation of a sample newsletter issue and a cover letter (which is essentially wrapped around the newsletter) to the prospect without the weakness of the intervening envelope, the device has not solved the problem of creating a fully separate continuation notice.

Response devices on wraps vary in type, however, they have never been separate pieces of paper entirely that are fully detachable and full size (i.e. the full size of the mailing itself versus simply a portion of the size of the mailing). Typical wrap response devices are perforated portions of the wrap or interior copy itself, and are constructed from the same paper as the wrap or interior newsletter. Due to the relatively small size of response devices on conventional wraps, they are often overlooked by the prospect.

Because the response devices on traditional wraps are limited to the wrap or newsletter material, they are not as effective as separate “continuation notices.” They do not stand out as continuation notices do from the rest of the mailing, and they do not have an instinctive “order form” feel that gives continuation notices their response power.

The present invention, by contrast, utilizes an entirely separate piece of paper than the wrap or the sample issue, allowing this piece to be separately printed (with a different printing process, e.g. laser printing vs. offset printing), on a separate color, so that it is separately detachable. This separate detachment produces an actual continuation notice that is attached to the wrap mailer. The resulting reply device, as a full format continuation notice, is superior to the typical wrap direct response device because it is (a) a full sheet of paper, (b) contains more specialized subscriber information that cannot be offset printed onto the form, and (c) may be on a different color paper than the rest of the mailing piece. In sum, because of these unique qualities, the present invention allows the mailing piece to contain a separately detachable order form that is far more recognizable as an order form than the typical wrap response device.

In essence, the present invention (hereinafter called the Combo) combines the most two important aspects of the newsletter solicitation: the sample issue and the continuation notice, without the introduction of an envelope to slow response and increase costs.

Without the present invention, marketers who want to send a prospect a full format continuation notice must use a separate mailing (if the marketer has first used a wrap), or must enclose the continuation notice in an envelope. In the first case, these separate mailings are typically conducted 7 to 10 days after the prospect receives the sample issue. This strategy, however, has two drawbacks compared to the present invention: (a) sending a separate continuation notice is more expensive, because of additional postage, handling, envelope, and inserting costs, and (b) the speed of response is slower since the prospect doesn't see a full format continuation notice until 7 to 10 days after they have seen the sample issue.

The Combo, in contrast, avoids these problems by presenting the continuation notice with the sample issue itself. Because the newsletter has a longer shelf life in the prospects hands than a separately mailed continuation notice, the Combo improves prospect response while at the same time speeding up response and reducing overall costs.

### SUMMARY OF THE INVENTION

The present invention concerns a method for improving on the limitations of traditional newsletter direct response mailings by allowing all of the components of the mailer (including sample issue, cover letter, complete continuation notice, and #9 reply envelope) to be mailed without an outer carrier envelope. This methodology greatly improves the effectiveness of newsletter direct response mailings while significantly reducing the cost of such mailings.

The present invention improves effectiveness by allowing prospects to see first hand the cover letter and content of the newsletter without having to first open an envelope. Thus, effectively, the invention connects prospects with marketers in a more direct way without the barrier of an envelope. Importantly, the present invention accomplishes this increased connectivity between marketer and prospect while maintaining the integrity of a continuation notice that can be detached and mailed in the by prospect with payment.

The present invention also reduces cost by eliminating the need for an outer carrier envelope, and eliminating the expensive process of inserting mailing pieces into an envelope.

The present invention also improves response time and yields more customer orders faster because is provides a separately printed continuation notice on a separate color of paper that is easily detached and easily recognized as an order form.

This methodology improves prospect response to the mailing piece because the continuation notice is clearly distinguished from the rest of the mailing package as an order form. The continuation notice format described herein is a recognizable format that calls the prospect to action because it resembles a form that is typically used for payment. Typically, wrap response devices are order forms, but they are not in a standard, recognizable format that is typically used for payment such as the continuation notice. This is by necessity because they are constructed as perforated portions of the wrap or the newsletter itself, and cannot be separately printed on separate color paper with the prospect's full identifying information, including association affiliation, and appropriate discount.

Thus, it is another object of the present invention to improve the order forms used by newsletter direct marketers so that they include more complete information associated with the prospect compared to the brief demographic information typically preprinted in wrap order forms.

This object is achieved by the present invention because the order forms are preprinted prior to assembly by a laser printing process that allows each individual order form to be created to match the prospect's particular attributes, including organization affiliation, respective discount, and prior business relationship with the marketer (i.e., if the prospect is an existing customer, and thus may be eligible for special discounts).

When presented to a prospect in place of traditional direct response methodologies, the present invention presents substantially more value of the marketer:

(a) The present invention is more cost effective because it eliminates the need for an outer carrier envelope and combines the newsletter with a separate continuation notice.

(b) The Combo more effectively connects the prospect with the marketing message that the marketer wants them to see without the barrier of an outside envelope, at the same time as not sacrificing the delivery of a full format continuation notice.

(c) The Combo provides a more effective order form than what is traditionally used on wraps because the continuation notice, while assembled as part of the package, is in fact separately printed, separately detachable, and produced on a different color of paper that is easily recognizable in the overall package. By including a full and complete separate continuation notice in the overall package in this manner provides a much more powerful response device than the traditional wrap order form, which is typically simply a perforated part of the newsletter or wrap paper, and does not stand out as a distinct attention-getting response device.

(d) The Combo improves the economics of the direct mail package because the marketer is able to send a continuation notice at the same time as the wrapped issue, compared to traditional strategies where the marketer must make a separate mailing at a later date note that the continuation notice is the main driver of direct response in such series, thus presenting a continuation notice to the prospect at the front-end of the series dramatically improves the speed of cash collection.

(e) The Combo also has the added benefit of improving the lifespan of the continuation notice. By attaching a full and complete version of this separate continuation notice directly to the wrap and sample issue, the prospect is more likely to retain the continuation notice for a longer period because the sample issue itself has a longer shelf life than stand alone continuation notices. Sample issues have longer shelf lives because they contain valuable content that prospects wish to read over time. Separately mailed continuation notices, however, contain no valuable content and are consequently quickly discarded by the prospect.

(f) The construction of the Combo is also superior to the wrap format because it takes advantage of die-cut technology, so that the outer wrap of the Combo is die cut to allow the address printed on the inside continuation notice to show through. This eliminates the need to print an address on the outside of the mailing package.

Some of the objects of the invention having been stated hereinabove, and which are addressed in whole or in part by the present invention, other objects will become evident as the description proceeds when taken in connection with the accompanying drawings as best described hereinbelow.

### BRIEF DESCRIPTION OF THE DRAWINGS

Preferred embodiments of the invention will now be explained with reference to the accompanying drawings, of which:

FIG. 1 is a front view of a wrap suitable for use with a method for marketing newsletter subscriptions according to an embodiment of the present invention;

FIG. 2 is a perspective view of a newsletter that may be used with a method for marketing newsletter subscriptions according to an embodiment of the present invention;

FIG. 3 is a top view of a continuation notice that may be used with a method for marketing newsletter subscriptions according to an embodiment of the present invention;

FIG. 4 is a front view of a return envelope that may be used with a method for marketing newsletter subscriptions according to the present invention;

FIG. 5 is a perspective view of a wrap and a continuation notice that may be used with a method for marketing newsletter subscriptions according to an embodiment of the present invention;

FIG. 6 is a top view illustrating exemplary components of a mailpiece suitable for use with a method for marketing newsletter subscriptions according to an embodiment of the present invention; and

FIG. 7 is a flow chart illustrating exemplary steps of a method for marketing newsletter subscriptions according to an embodiment of the present invention.

### DETAILED DESCRIPTION OF THE INVENTION

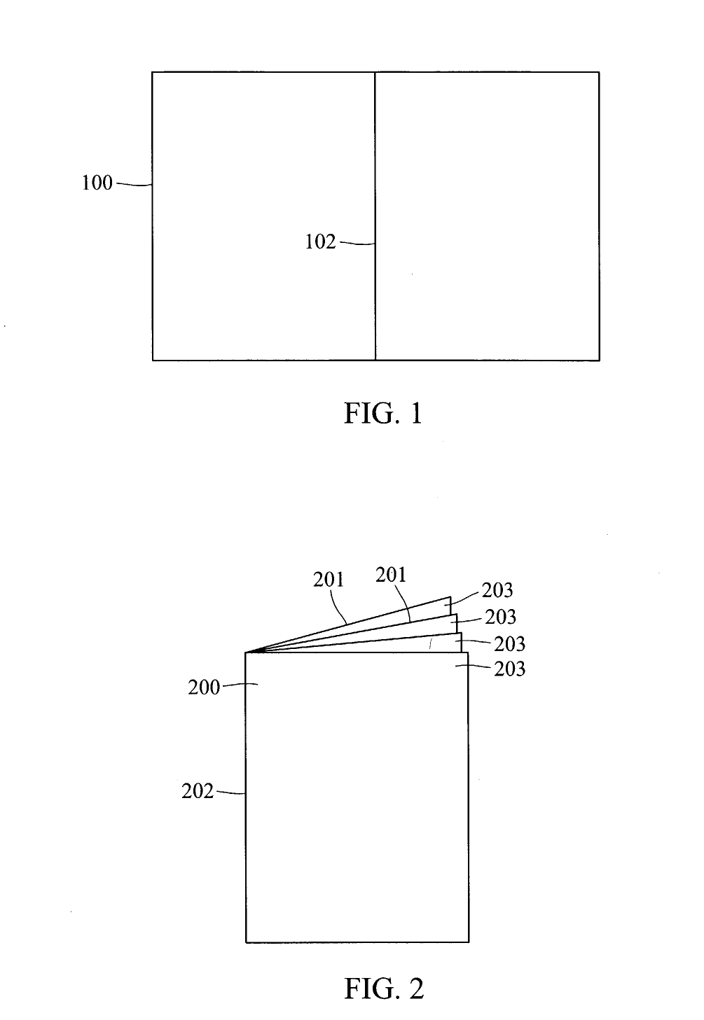

FIG. 1 illustrates a wrap that may be combined with a newsletter and used in a newsletter subscription marketing method according to an embodiment of the present invention. In FIG. 1, wrap 100 comprises a sheet article designed to be wrapped around a newsletter. For example, in order to be wrapped around a newsletter with 8.5×11 inch pages, wrap 100 may be an 11×17 inch sheet article such that when folded along fold line 102, wrap 100 comprises four pages. Wrap 100 may include marketing material, such as printed headlines of the newsletter content to induce the prospective subscriber to read the newsletter. As used herein, the term “prospective subscriber” is intended to include a non-subscriber of a newsletter and an existing subscriber whose subscription needs to be renewed.

FIG. 2 illustrates an example of a newsletter that may be combined with a continuation notice and used in a newsletter subscription marketing method according to an embodiment of the present invention. In FIG. 2, newsletter 200 includes a plurality of sheet articles 201. In the illustrated example, each sheet article 201 is folded about its midpoint line 202 to form a plurality of pages 203. Each page 203 preferably includes information that is of interest to a prospective subscriber. For example, if the prospective subscriber is a physician, newsletter 200 may include articles relating to the business side of practicing medicine, such as Medicare compliance, reimbursement, and coding.

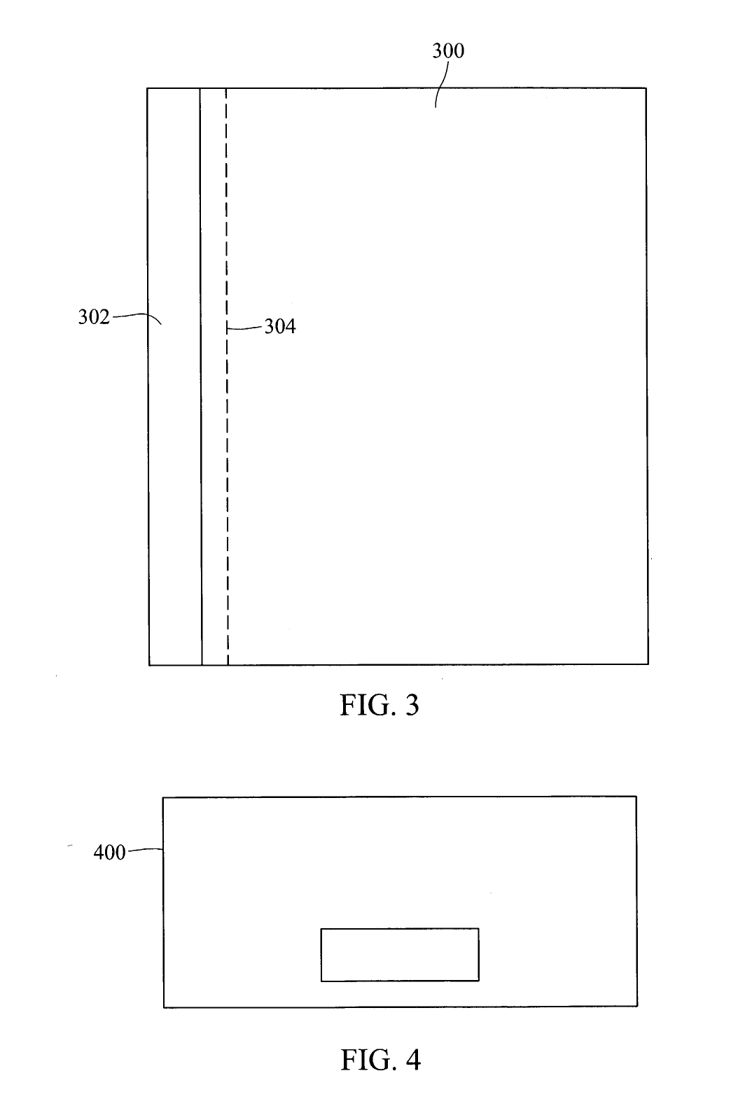

FIG. 3 illustrates another example of a continuation notice that may be included in a newsletter subscription marketing method according to an embodiment of the present invention. In FIG. 3, continuation notice 300 comprises a sheet article. The sheet article is preferably dimensioned such that it is at least as large as pages 203 of newsletter 200 illustrated in FIG. 2. For example, if pages 203 are 8.5×11 inches, continuation notice 300 is preferably at least 8.5×11. inches so that it will appear to be of equal importance to the prospective subscriber. In the illustrated example, continuation notice 300 is dimensioned to be larger in width than newsletter pages 203 to facilitate combining with newsletter pages 203. In particular, continuation notice 300 may include a lip 302 that can be folded with pages 203 along their respective fold lines 202. Lip 302 can then be attached to newsletter 200 using an appropriate binding method, such as stapling. Continuation notice 300 may also include a perforation 304 to facilitate detachment from newsletter 200 once bound.

FIG. 4 illustrates an example of a return envelope that may be included in a newsletter subscription marketing according to an embodiment of the present invention. In FIG. 4, envelope 400 is preferably dimensioned such that its length is equal to the width of continuation notice 300 illustrated in FIG. 3 after continuation notice has been torn from newsletter 200 using perforation 304. For example, if continuation notice 300 is 8.5 inches wide after being removed from newsletter 200, the envelope 400 is preferably a number nine envelope. Envelope 400 may be folded across its midpoint and attached to newsletter 200 in a manner that will be illustrated in more detail below.

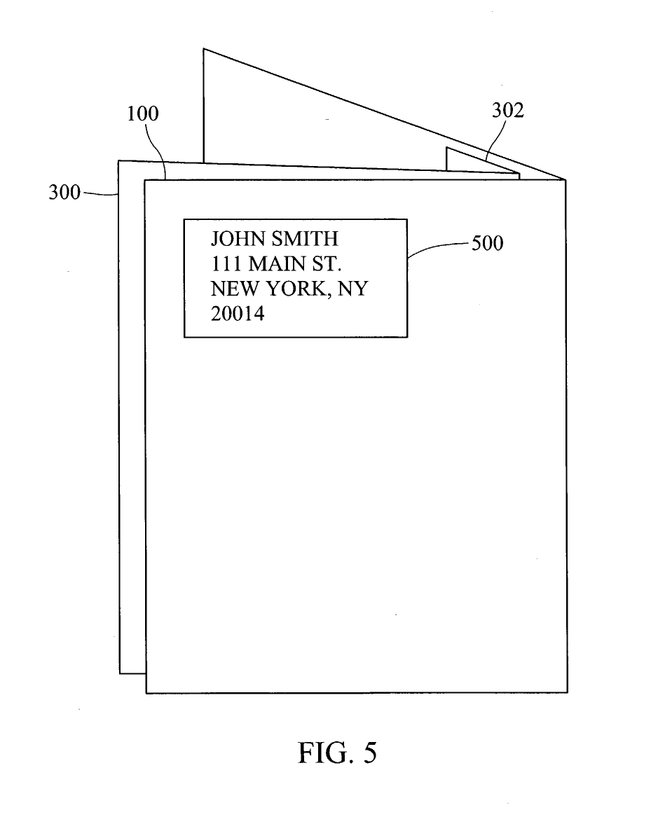

FIG. 5 is a perspective view of wrap 100 and continuation sheet 302 that may be used in a newsletter subscription marketing method according to an embodiment of the present invention. In the illustrated example, wrap 100 includes a window 500 that may be used to view address information, printed on continuation notice 300. Window 500 may be formed in any suitable means, such as die cutting. Using window 500 to display address information eliminates the need for separately printing the intended subscribers address on the outside of wrap 100. In addition window 500 may also increase the likelihood that the prospective subscriber will notice the continuation notice and order the newsletter.

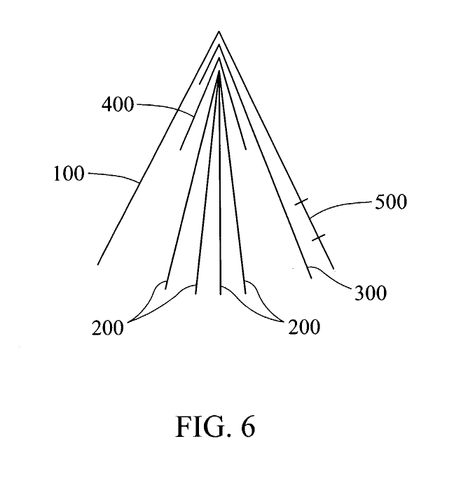

FIG. 6 is a top view of a mailpiece including a newsletter and an integrated full sized continuation notice that may be used with a newsletter subscription marketing method according to an embodiment of the present invention. In the illustrated example, wrap 100 is folded to form the front and back pages of the mailpiece. Continuation notice 300 is the second to last page of the mailpiece. Window 500 allows viewing of the intended recipients address printed on continuation notice 300. Newsletter 200 preferably contains content of interest to the prospective subscriber. Return envelope 400 preferably contains prepaid postage to increase the likelihood that the subscriber will return the continuation notice.

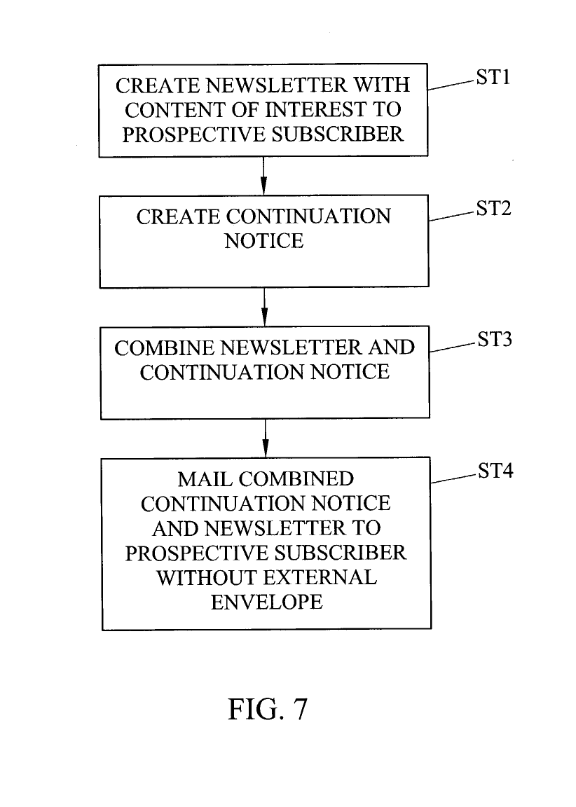

FIG. 7 is a flow chart of a method for marketing a newsletter subscription according to an embodiment of the present invention. Referring to FIG. 7, in step ST1, a newsletter publisher or mailer (hereinafter, the “user”) creates a newsletter containing content of interest to a prospective subscriber. This step may include identifying and obtaining content and printing the content on sheet articles. In step ST2, the user creates a continuation notice to be included with the sheet article. The continuation notice may include a contract that offers a subscription of the newsletter to the prospective subscriber. The continuation notice may also include address information for the prospective subscriber so that the address does not need to be reprinted on the outside of the newsletter. In step ST3, the user combines the continuation notice with the newsletter. This step may include interleaving the continuation notice with the sheet articles that make up the newsletter, folding the sheet articles and the continuation notice, and binding the continuation notice to the sheet articles. In step ST4, the user mails combined newsletter and continuation notice to the prospective subscriber without using an external envelope. The recipient address information may be obtained by viewing the address information through window 500. The back cover of the newsletter may also include prepaid or other appropriate postage.

The steps illustrated in FIG. 7 may be repeated for subscribers with common interests. For example, a newsletter regarding a physician's practice may be sent to all of the physicians in a given geographic area. Similarly, a newsletter on recent legal decisions in a particular legal field may be sent to all lawyers practicing in that field in a given geographic area. Using any type of newsletter content is intended to be within the scope of the invention.

As discussed above, a method for marketing newsletter subscriptions according to embodiments of the present invention increases the likelihood of obtaining new subscribers and decreases the costs required for force free trials. Combining the continuation notice and the newsletter in a single mailing reduces postage costs because a single mailing replaces what was previously accomplished using two mailings. In addition, providing a full size continuation notice with the newsletter decreases the likelihood that the continuation notice will be overlooked or discarded. Finally, mailing the continuation notice and the newsletter in a single mailing without an external envelope increases the likelihood that the prospective subscriber will actually read the newsletter and become a paying subscriber.

It will be understood that various details of the invention may be changed without departing from the scope of the invention. Furthermore, the foregoing description is for the purpose of illustration only, and not for the purpose of limitation, as the invention is defined by the claims as set forth hereinafter.

What is claimed is:

1. A method for marketing a newsletter subscription, the method comprising:
(a) creating a newsletter including content of interest to a prospective subscriber, the newsletter including a plurality of pages, each page having a first size;
(b) creating a continuation notice including ordering information for allowing a prospective subscriber to continue receiving the newsletter, the continuation notice having at least the first size;
(c) combining the continuation notice and the newsletter; and
(d) mailing the combined continuation notice and newsletter to the prospective subscriber without using an external envelope.

2. The method of claim 1 wherein creating a newsletter includes feeding first sheets having first and second sides into a printer, printing current newsletter content of interest to the prospective subscriber on the first and second sides, folding each of the first sheets into first and second halves, wherein each side of each half forms a page.

3. The method of claim 2 wherein creating the continuation notice includes printing the ordering information on a second sheet separate from the first sheets.

4. The method of claim 3 wherein combining the continuation notice with the newsletter includes:
(a) inserting the second sheet between two of the first sheets such that the second sheet overlaps the first and second halves of the first sheets;
(b) folding the second sheet between the first sheets; and
(c) binding the second sheet to the first sheets.

5. The method of claim 1 wherein creating the continuation notice includes perforating the continuation notice to allow separation from the newsletter.

6. The method of claim 1 wherein creating a continuation notice includes providing information in the continuation notice that is tailored to the prospective subscriber.

7. The method of claim 1 comprising inserting a return mail envelope for the continuation notice between the first sheets and combining the return mail envelope with the first sheets and the continuation notice.

8. The method of claim 1 wherein creating a continuation notice includes creating a continuation notice including postal address information of the prospective subscriber.

9. The method of claim 8 comprising die-cutting a window in the newsletter such that postal address information is visible without opening the newsletter.

10. The method of claim 8 comprising folding a wrap around the newsletter and the continuation notice.

11. The method of claim 8 comprising die-cutting a window in the wrap such the postal address is visible without opening the newsletter.

12. A method for creating a mailpiece for successful newsletter subscription marketing, the method comprising:
(a) generating a newsletter including a plurality of pages of a first size, the newsletter including information of interest to a prospective subscriber;
(b) generating a continuation notice for continuing subscription of the newsletter on a page of at least the first size, the continuation notice including mailing address information for the prospective subscriber;
(c) interleaving the continuation notice with the pages of the newsletter;
(d) binding the continuation notice and the newsletter; and
(e) die-cutting a window in the newsletter so that the address information is visible without opening the newsletter.
